(19) United States
(12) Patent Application Publication
(10) Pub. No.: US 2015/0058501 A1
(43) Pub. Date: Feb. 26, 2015

(54) INFORMATION PROCESSING APPARATUS AND INFORMATION PROCESSING METHOD

(71) Applicant: Kabushiki Kaisha Toshiba, Tokyo (JP)

(72) Inventors: Hideki WATANABE, Tokyo (JP); Reina WATANABE, Tokyo (JP)

(21) Appl. No.: 14/458,782

(22) Filed: Aug. 13, 2014

Related U.S. Application Data
(60) Provisional application No. 61/868,689, filed on Aug. 22, 2013.

(51) Int. Cl. G06F 11/30; G06F 11/34

(52) U.S. Cl. CPC G06F 11/3027; G06F 11/3452; G06F 2211/002
USPC 710/18

(57) ABSTRACT

An information processing method of the embodiment is related to an information processing apparatus having a dedicated port serving as a first kind general-purpose port and a combo port serving as both the first kind general-purpose port and a kind second general-purpose port. The method includes an accumulation step, an analysis step and a notification step. The accumulation step accumulates data about use status of each of the general-purpose ports. The analysis step analyzes the data about the use status of each of the general-purpose ports based on the accumulation of the data. The notification step sends a notification of efficient use of the general-purpose ports to the outside based on the analysis of the data.

### CROSS-REFERENCE TO RELATED APPLICATION(S)

This application claims priority from U.S. Provisional Patent Application No. 61/868,689 filed on Aug. 22, 2013, the entire contents of which are incorporated herein by reference.

### TECHNICAL FIELD

An embodiment of the invention relates to an information processing apparatus and an information processing method.

### BACKGROUND ART

For example, it relates to an information apparatus etc. having plural USB ports including an eSATA/USB combo port.

Typically, an information processing apparatus such as a personal computer (PC) is provided with a USB connector to which a USB (Universal Serial Bus) cable can be connected. The USB connector typically has a housing (so-called shell) made of metal, and a terminal portion provided inside the housing. On the other hand, a plug (i.e. terminal portion) which can be inserted into the housing of the USB connector is provided in a front end of the USB cable.

The information processing apparatus is also provided with an interface called an eSATA (external Serial ATA) interface which enables high speed communication with an external apparatus at a data transfer speed up to 300 MB/second.

In recent years, an apparatus mounted with a dual interface (eSATA/USB combo port) compatible with both the USB connector and an eSATA interface connector (hereinafter referred to as eSATA connector) has been proposed.

As a problem, there is a case where a user who uses a notebook PC (Personal Computer) mounted with an eSATA/USB combo port does not recognize that the user can use the eSATA combo port to connect a USB device thereto because the port has a slightly different shape from a normal USB port. When plural USB devices are connected to the PC, the user may be not aware of the eSATA/USB combo port which is idle, but may connect a device to the PC through a USB hub in spite of the existence of the idle eSATA/USB combo port.

### BRIEF DESCRIPTION OF DRAWINGS

FIG. 1 is front perspective view showing an information processing apparatus according to one embodiment of the invention.

FIG. 2 is back perspective view showing the information processing apparatus according to the embodiment.

FIG. 3 is perspective view showing an enlarged region encircled by a line F3 in the information processing apparatus shown in FIG. 2.

FIG. 4 is block diagram showing the system configuration of the information processing apparatus in FIGS. 1 and 2.

FIG. 5 is view showing an eSATA/USB combo port and a USB port used in the embodiment.

FIG. 6 is flow chart showing accumulation of data(recorded every predetermined time) about use status of each USB port according to the embodiment.

FIG. 7 is view showing an example of accumulated data used in the embodiment.

FIG. 8 is flow chart showing analysis of data about the use statuses of the USB ports used in the embodiment.

FIG. 9 is view 1 showing examples of port use rates according to the embodiment.

FIG. 10 is view showing an example of a screen for notification to a user according to the embodiment.

FIG. 11 is view 2 showing examples of port use rates according to the embodiment.

FIG. 12 is flow chart showing accumulation of data (recorded whenever a device is inserted/detached) about use status of each USB port according to the embodiment.

FIG. 13 is flow chart showing analysis of data about use status of each USB port according to another embodiment.

### DESCRIPTION OF EMBODIMENTS

Embodiments will be described below.

### First Embodiment

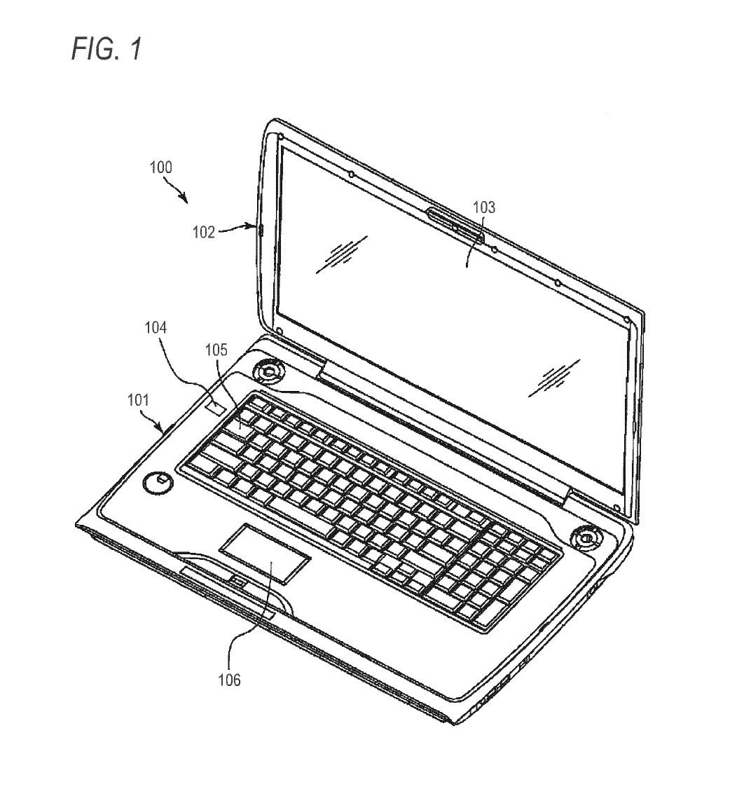

Embodiments will be described below with reference to the drawings. First, the configuration of an information processing apparatus according to one embodiment will be described with reference to FIGS. 1 to 3. For example, this information processing apparatus is implemented as a notebook-type personal computer 100 (hereinafter shortened to computer 100) which can be battery-driven.

FIG. 1 is a front perspective view of the computer 100 with its display unit opened. The computer 100 includes a body unit 101 and a display unit 102. A display device consisting of an LCD (Liquid Crystal Display) 103 is embedded into the display unit 102. A display portion of the LCD 103 is disposed substantially in the center of the display unit 102.

The display unit 102 is supported on the body unit 101. The display unit 102 is attached to the body unit 101 so as to be rotatable between an open position and a closed position with respect to the body unit 101. In the open position, the upper surface of the body unit 101 is exposed. In the closed position, the upper surface of the body unit 101 is covered. The body unit 101 has a thin box-like housing. A power button 104 for powering ON/OFF the computer 100, a keyboard 105, and a touch pad 106 etc. are disposed in the upper surface of the body unit 101. A circuit board which is a mother board, etc. is accommodated inside the aforementioned housing.

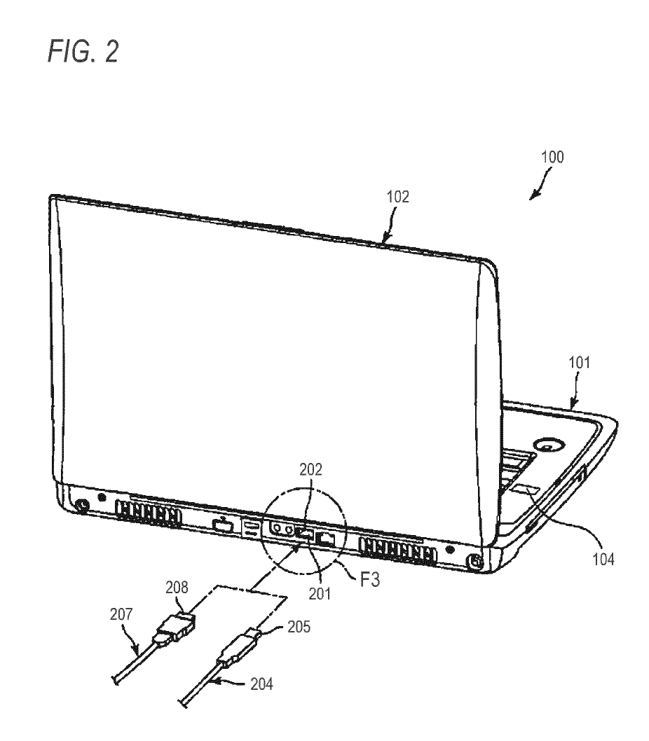

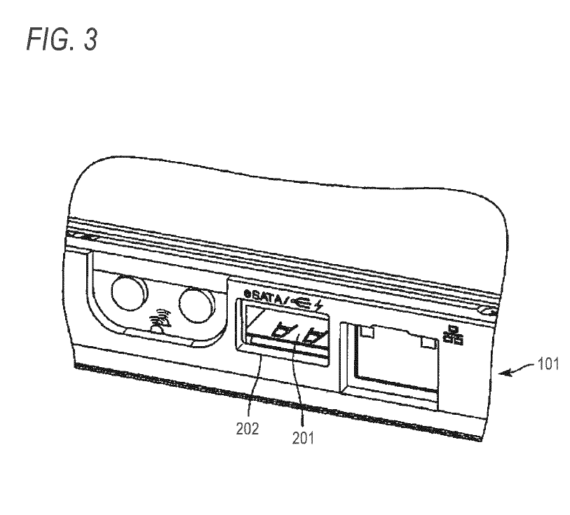

FIG. 2 is a back perspective view of the computer 100 with its display unit opened. FIG. 3 is a perspective view showing an enlarged region encircled by a line F3 in the computer 100 shown in FIG. 2.

As shown in FIGS. 2 and 3, a connector 201 is mounted in the body unit 101. Herein, the connector is a so-called socket connector meaning a connector which receives a plug of a cable (that is, a terminal portion of a cable).

As shown in FIGS. 2 and 3, for example, the connector 201 is mounted on the aforementioned circuit board and received inside the housing. An opening portion 202 opposed to the connector 201 is provided in a peripheral wall of the housing. The connector 201 is exposed to the outside of the housing through the opening portion 202 so that a plug 205 of a USB cable 204 can be inserted into the connector 201 from the outside (that is, a USB cable 204 can be connected to the connector 201).

This connector 201 is an eSATA/USB combo connector to which both the USB cable 204 and an eSATA cable 207 can be alternatively connected. Accordingly, a plug 208 of the eSATA cable 207 can be inserted into the connector 201 from the outside (that is, the eSATA cable 207 can be connected to the connector 201), in the same manner as the USB cable 204.

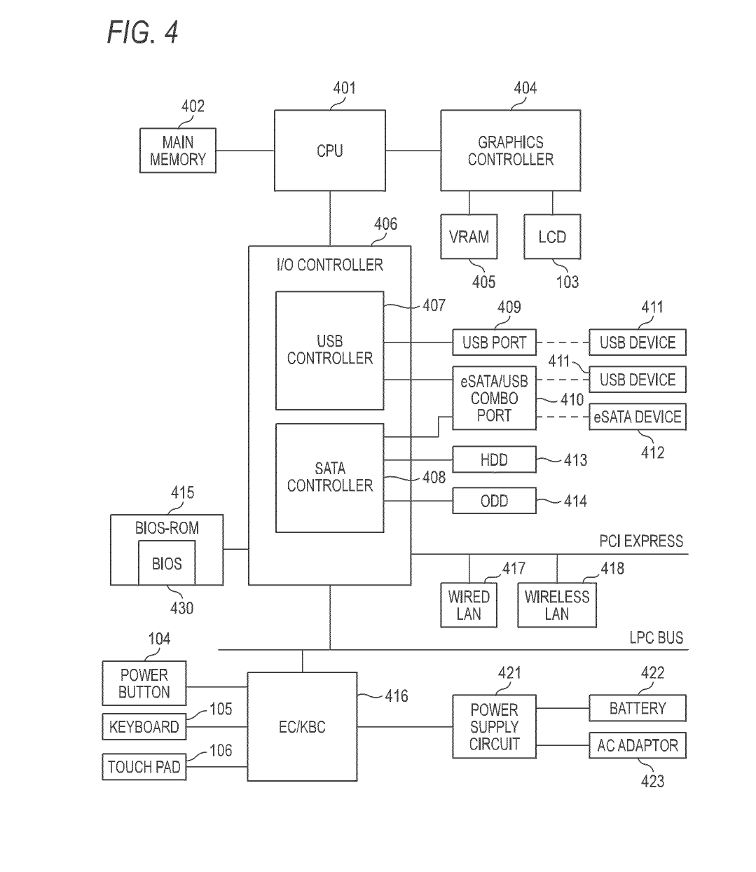

FIG. 4 is a block diagram showing the system configuration of the computer 100 according to the embodiment.

As shown in FIG. 4, the computer 100 is provided with a CPU 401, a main memory 402, a graphics controller 404, the LCD 103, a VRAM 405, an I/O controller 406, a USB controller 407, an SATA controller 408, a USB port 409, an eSATA/USB combo port (function corresponding to the connector 201 in FIGS. 2 and 3) 410, USB devices 411, an eSATA device 412, a hard disk drive (HDD) 413, an optical disk drive (ODD) 414, a BIOS-ROM 415, the power button 104, the keyboard 105, the touch pad 106, an embedded controller/keyboard controller (EC/KBC) 416, a power supply circuit 421, a battery 422, an AC adaptor 423, etc.

The CPU 401 is a processor which controls the overall operation of the computer 100. The CPU 401 executes an OS and various application programs loaded into the main memory 402. The OS and the various application programs are stored in a magnetic disk storage medium (hard disk), etc. mounted in the HDD 413 and loaded into the main memory 402 from the storage medium.

The CPU 401 also executes a BIOS program 430 (hereinafter referred to as BIOS) stored in the BIOS-ROM 415. The BIOS-ROM 415 takes the form of a nonvolatile memory such as a flash EEPROM, which can store programs rewritably.

The BIOS 430 is a program which controls various hardware components of the computer 100. The BIOS 430 is read out from the BIOS-ROM 415 when the computer 100 is started up. A program allowing the computer 100 to execute power supply control operation according to the embodiment is also stored in the BIOS 430.

The CPU 401 is provided with a memory controller which controls access to the main memory 402. The CPU 401 has a function of making communication with the graphics controller 404 through a PEG (PCI Express for Graphics) bus etc.

The graphics controller 404 is a controller which controls the LCD 103 used as a display monitor of the computer 100. The graphics controller 404 outputs a video signal corresponding to display data written in the VRAM 405 to the LCD 103 in accordance with the OS or any of the application programs.

The I/O controller 406 controls various devices on an LPC (Low Pin Count) bus and a PCI (Peripheral Component Interconnect) Express bus. The USB controller 407 for controlling USB devices 411, and the SATA controller 408 for controlling an eSATA device 412, the HDD 413, and the ODD 414 are built in the I/O controller 406.

As described above, the eSATA/USB combo port 410 can alternatively connect either a USB device 411 or an eSATA device 412 to the corresponding controller 407 or 408. The USB device 411 can be also connected to the corresponding controller 407 through a connector of the USB port 409 provided in the computer 100.

The HDD 413 is a storage device having a hard disk controller and a magnetic disk storage medium. For example, various kinds of software including the OS and various kinds of data can be stored in the magnetic disk storage medium. Although a hard disk drive (HDD) having a magnetic disk storage medium is exemplified in this embodiment, any kind of storage device can be used. For example, a solid state drive (SSD) may be used instead of or in addition to a hard disk drive (HDD). The ODD 414 is a drive unit for driving a storage medium such as a DVD storing video contents such as a DVD title, a CD storing music data, a DVD/ROM or CD-ROM recording data, etc.

The EC/KBC 416 is a one-chip microcomputer into which an embedded controller (EC) for management of electric power and a keyboard controller (KBC) for controlling the keyboard 105 and the touch pad 106 are integrated. The EC/KBC 416 is always powered on by electric power from the power supply circuit 421 regardless of whether the computer 100 has been powered ON or OFF. The EC/KBC 416 works with the power supply circuit 421 to power ON/OFF the computer 100 in response to an operation performed on the power button 104 by a user.

The power supply circuit 421 uses electric power from the battery 422 provided inside the body unit 101 or electric power supplied from an external power supply through the AC adaptor 423 to supply electric power to respective devices under the control of the EC/KBC 416.

Operation in the computer 100 having the aforementioned configuration will be described below. Assume that the notebook PC in the embodiment is provided with both a “USB port” and an “eSATA/USB combo port”.

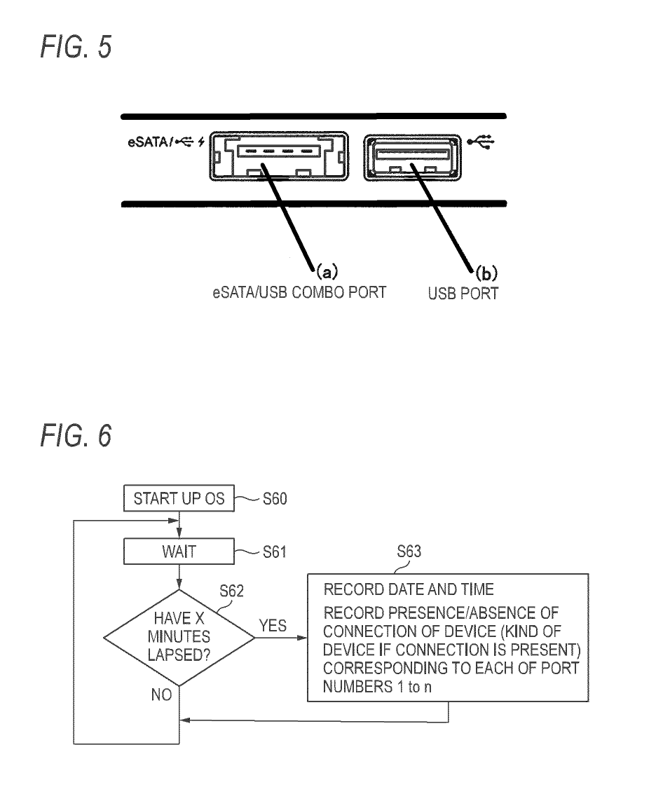

The shape of the eSATA/USB combo port and the shape of the USB port are schematically shown in FIG. 5. Since the shape of the eSATA/USB combo port in (a) of FIG. 5 is different from the shape of the USB port in (b) of FIG. 5, there may be a case in which a user cannot recognize at a glance that the user can use the eSATA/USB combo port as a USB port. Therefore, a solution to this problem will be offered in the following description.

That is, in the notebook PC having the USB port and the eSATA/USB combo port, a program for recording and accumulating, as data, information about “what device is connected to which port” during operation of the PC is provided inside the OS.

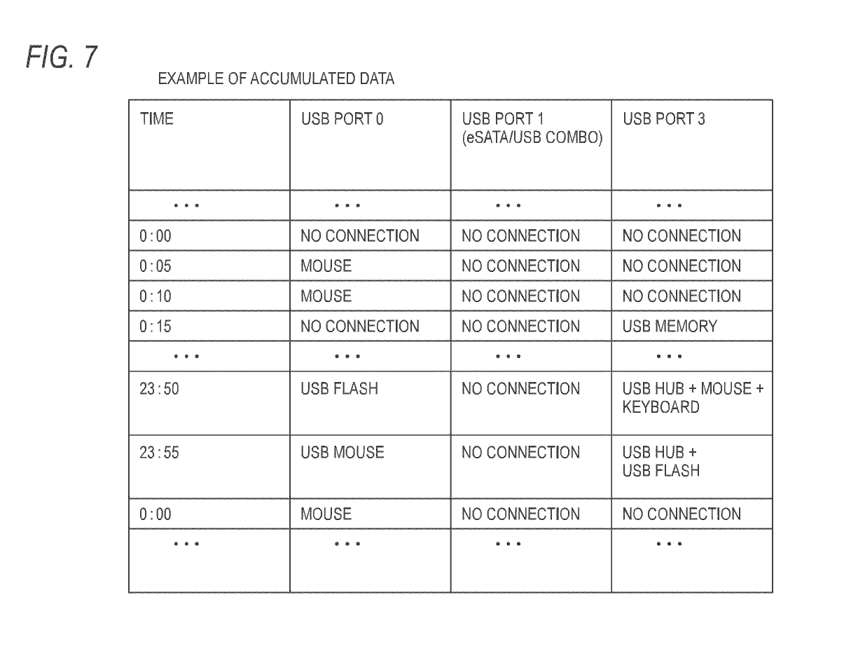

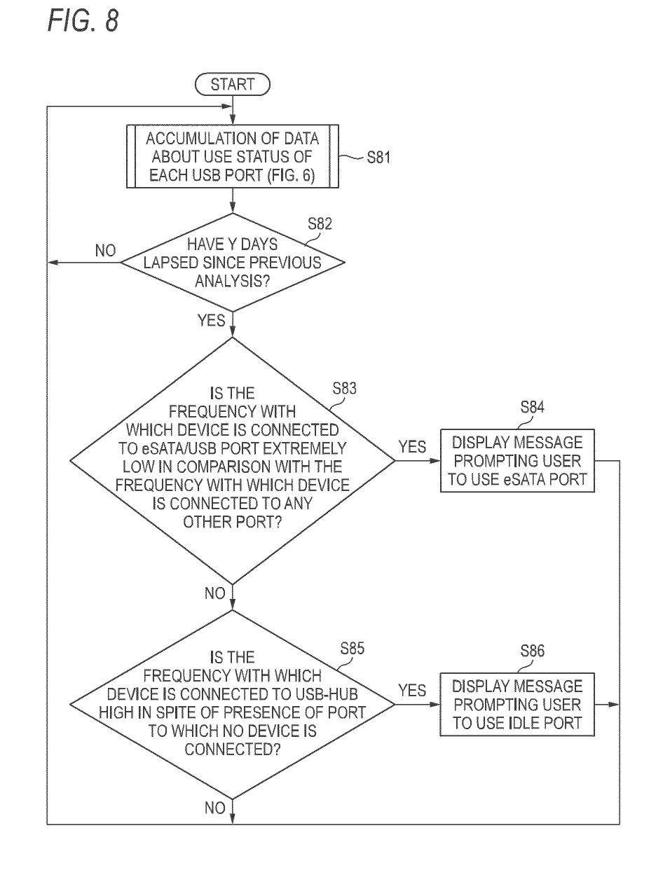

A flow of the data accumulation is shown in FIG. 6. When the OS is started up (Step S60), the OS waits (Step S61). When a lapse of time reaches X minutes (Step S62, for example, 5 minutes), the OS records the date and time and records presence/absence of connection of a device (the kind of the device if the connection is present) corresponding to each of port numbers 1 to n (Step S63). Then, the OS resets the lapse and returns to Step 561. When the lapse has not reached X minutes yet, the OS waits continuously as it is.

An example of the case where the connection status of each port is recorded every predetermined time is shown in FIG. 7 as an example of the data accumulation based on such recording. Information such as the kind of a device can be obtained by reading a descriptor of a USB device. In the example, numbers 0, 1 and 3 are assigned to general-purpose ports which are opened to the outside of the housing.

A program for analyzing the connection status of each user's USB device based on accumulated data about “the connection status of a device to each USB port” is provided inside the OS. A flow of the data analysis is shown in FIG. 8. The program makes analysis every predetermined time as to whether there is or not a tendency as follows. For example, the program makes analysis once every two weeks on a basis of the total drive time.

Step S81: The flow of data accumulation in FIG. 6 is repeated from Step S61 to Step S63.

Step S82: Determination is made as to whether Y days (for example, 14 days) have lapsed or not since the previous analysis. When the conclusion is No, the flow returns to Step S81. When the conclusion is Yes, the flow advances to the next step.

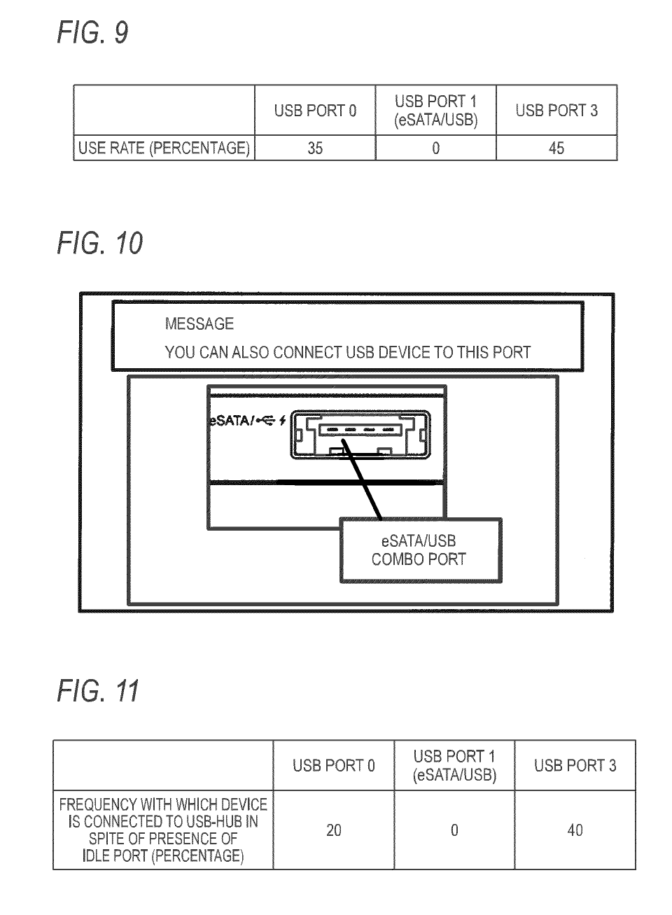

Step S83: Determination is made as to whether the frequency with which a USB device is connected to the eSATA/USB combo port is extremely low or not in comparison with the frequency with which a USB device is connected to any other port. When the conclusion is No, the flow advances to Step S85. When the conclusion is Yes, the flow advances to Step S84. Conclusion may be made that the eSATA/USB combo port has not been used yet at all or conclusion may be made that, for example, the use rate of the eSATA/USB combo port is not higher than half the lower one of the use rates of the USB port 0 and the USB port 3, as in FIG. 9.

Step S84: A message prompting a user to use the eSATA/USB combo port is displayed (see FIG. 10). The flow returns to Step S81. That is, the program is provided to display a message reminding the user that a USB device may be also connected to the eSATA/USB port and to prompt the user to make effective use of any idle USB port.

Step S85: Determination is made as to whether the frequency with which a device is connected to a USB-HUB in spite of the presence of a port to which no device is connected is high or not. When the conclusion is No, the flow returns to Step S81. When the conclusion is Yes, the flow advances to Step S86. In FIG. 11, determination is made as to whether the frequency with which “a device is connected to a USB-HUB in spite of the presence of a USB port to which no device is connected” exceeds a predetermined threshold (for example, 30%) or not.

Step S86: A message prompting the user to use the idle port is displayed. Then, the flow returns to Step S81.

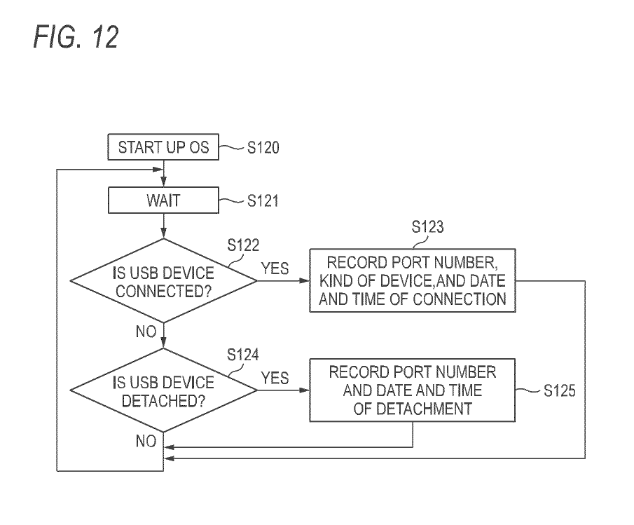

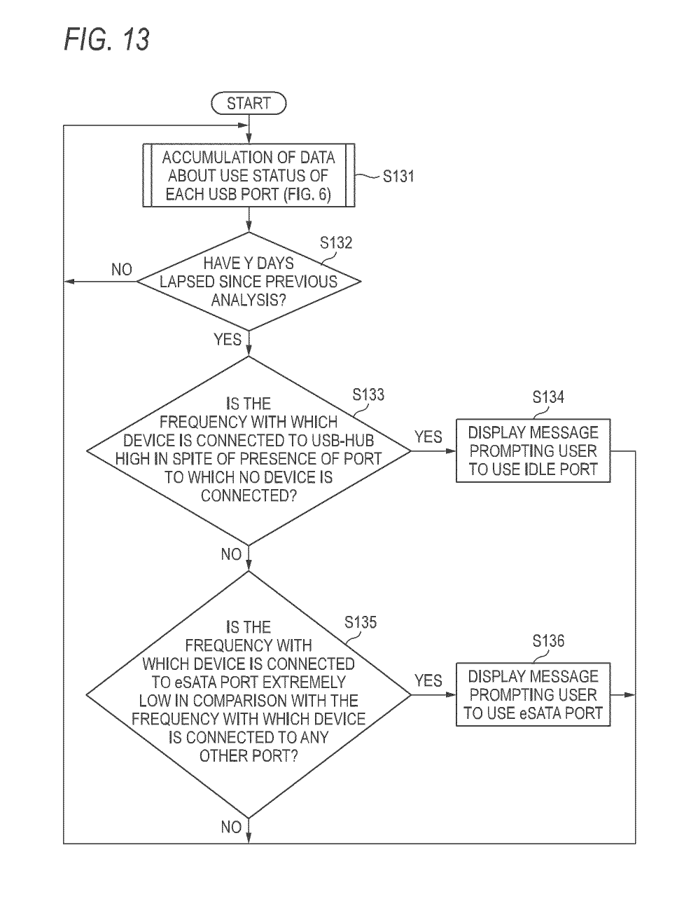

According to another embodiment or a modification in place of FIG. 6, the connection status of a USB device to each port may be recorded whenever a USB device is inserted/detached into/from a USB port. The flow thereof will be shown in FIG. 12.

When the OS is started up (Step S120), the OS waits (Step S121). The OS determines whether a USB device is connected or not (Step S122). When conclusion is made that a USB device is connected, the OS records the port number, the kind of the device and the date and time of the connection (Step S123) and then returns to Step S121. On the other hand, when conclusion is made that a USB device is not connected, the OS determines whether a USB device is detached or not (Step S124). When conclusion is made that a USB device is detached, the OS records the port number and the date and time of the detachment (Step S125). In any case, the OS returns to Step S121.

The quantity of accumulated data in this case can be reduced in comparison with that in the case in which “data are accumulated every predetermined time”.

### Second Embodiment

A second embodiment of the invention will be described with reference to FIG. 13. Description about parts in common with those of Embodiment 1 will be omitted.

A program for analyzing the connection status of each user's USB device based on accumulated data about “the connection status of a device to each USB port” is provided inside the OS. A flow of the data analysis is shown in FIG. 13. The program makes analysis every predetermined time as to whether there is or not a tendency as follows. For example, the program makes analysis once every two weeks on a basis of the total drive time. The determination sequence in the latter part of the flow is reverse to that in FIG. 8 so as to be usefully applied even to a configuration having USB ports only. For example, in Step S134, a message can be sent to a user who forgets or does not know how many USB ports are provided and where (the left side, the rear side, the right side, etc. of the housing) each USB port is opened.

Step S131: The flow of data accumulation in FIG. 6 is repeated from Step S61 to Step S63.

Step S132: Determination is made as to whether Y days (for example, 14 days) have lapsed or not since the previous analysis. When the conclusion is No, the flow goes to Step S131. When the conclusion is Yes, the flow advances to the next step.

Step S133: Determination is made as to whether the frequency with which a device is connected to a USB-HUB in spite of the presence of a port to which no device is connected. When the conclusion is No, the flow advances to Step S135. When the conclusion is Yes, the flow advances to Step S134.

Step S134: A message prompting a user to use the idle port is displayed. Then, the flow returns to Step S131.

Step S135: Determination is made as to whether the frequency with which a device is connected to the eSATA/USB combo port is extremely low or not in comparison with the frequency with which a device is connected to any other port. When the conclusion is No, the flow returns to Step S131. When the conclusion is Yes, the flow advances to Step S136.

Step S136: A message prompting the user to use the eSATA/USB combo port is displayed. Then, the flow returns to Step S131.

When data about the connection status of a device to each USB port are accumulated and analyzed as described above, the user can be prompted to connect

USB devices effectively. The user can avoid a situation that the user need to connect a device via a USB-HUB though there are enough USB ports in the PC in comparison with the number of devices which need to be connected.

That is, in a notebook PC having plural USB ports including an eSATA/USB combo port, “how frequently” “what kind of device” is connected to each of the USB ports is recorded as data and the data are accumulated.

The user's use status of each USB port is periodically analyzed based on the accumulated data, and determination is made as to whether there are or not tendencies as follows.

(1) The frequency with which connection is made through a USB-HUB in spite of the presence of an idle USB port exceeds a predetermined threshold.

(2) The frequency with which a device is connected to the eSATA/USB combo port is extremely low in comparison with the frequency with which a device is connected to any other port.

When the user's use status satisfies these conditions, a message prompting the user to use the eSATA/USB port or the idle USB port is displayed.

The embodiments which can improve the use rate of the eSATA/USB combo port etc. have been described. When the use status of each USB port over time is analyzed and displayed thus, a user can be prompted to use the USB ports effectively.

The invention is not limited to the aforementioned embodiments. In addition thereto, the invention may be modified variously in a practical stage without departing from the spirit and scope of the invention.

When plural constituent elements disclosed in each of the aforementioned embodiments are combined suitably, various inventions can be formed. For example, some constituent elements may be removed from the whole constituent elements shown in each of the embodiments. Constituent elements according to different embodiments may be combined suitably.

1. An information processing method for an information processing apparatus comprising a first general-purpose port and a combo port configured to serve as both a second general-purpose port and a third general-purpose port, the method comprising:
accumulating data by the information processing apparatus about use status of each of the first second and third general-purpose ports;
analyzing the data about the use status of each of the first second and third general-purpose ports based on the accumulation of the data; and
sending a notification of efficient use of the first second and third general-purpose ports to the outside based on the analysis of the data.

2. The method of claim 1,
wherein the first general-purpose port is a first USB port.

3. The method of claim 1,
wherein the third general-purpose port is an eSATA/USB combo port and the second general-purpose port is a second USB port.

4. An information processing method for an information processing apparatus comprising general-purpose ports, the method comprising:
accumulating data by the information processing apparatus about use status of each of the general-purpose ports;
analyzing the data about the use status of each of the general-purpose ports based on the accumulation of the data; and
sending a notification of efficient use of the general-purpose ports to the outside based on the analysis of the data.

5. An information processing apparatus comprising a first general-purpose port and a combo port configured to serve as both a second general-purpose port and a third general-purpose port, further comprising:
an accumulation controller configured to accumulate data about use status of each of the first second and third general-purpose ports;
an analysis controller configured to analyze the data about the use status of each of the first second and third general-purpose ports based on the accumulation of the data; and
a notification controller configured to send a notification of efficient use of the first second and third general-purpose ports to the outside based on the analysis of the data.
